(19) United States
(12) Patent Application Publication
(10) Pub. No.: US 2026/0129531 A1
(43) Pub. Date: May 7, 2026

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(21) Appl. No.: 19/442,095

(22) Filed: Jan. 7, 2026

Related U.S. Application Data
(63) Continuation of application No. PCT/CN2023/112691, filed on Aug. 11, 2023.

(51) Int. Cl. H04W 36/04; H04W 36/00; H04W 74/0838

(52) U.S. Cl. CPC H04W 36/04; H04W 36/0058; H04W 74/0838

(57) ABSTRACT

Provided are a wireless communication method, a terminal device, and a network device. The method comprises: if a terminal device determines to hand over to a first LTM candidate cell, the terminal device executes a first operation, wherein the first operation comprises one or more of the following: initiating a random access procedure; and transmitting first uplink data in the first LTM candidate cell on the basis of a first CG resource, the transmission of the first uplink data being a first uplink transmission of the terminal device in the first LTM candidate cell.

### CROSS-REFERENCE TO RELATED APPLICATIONS

This application is a continuation of International Application No. PCT/CN2023/112691, filed on August 11, 2023, the disclosure of which is hereby incorporated by reference in its entirety.

### TECHNICAL FIELD

This application relates to the field of communications technologies, and more specifically, to a wireless communication method, a terminal device, and a network device.

### RELATED ART

A layer 1/layer 2-triggered mobility (LTM) procedure is a cell handover procedure triggered based on L1/L2 signalling. In an LTM procedure, when a terminal device determines to be handed over to an LTM candidate cell, how to access the LTM candidate cell is a problem to be resolved.

### SUMMARY

Embodiments of this application provide a wireless communication method, a terminal device, and a network device. The following describes in detail various aspects involved in embodiments of this application.

According to a first aspect, a wireless communication method is provided, and includes: performing, by a terminal device, a first operation in a case that the terminal device determines to be handed over to a first LTM candidate cell, where the first operation includes one or more of following: initiating a random access procedure; or transmitting first uplink data in the first LTM candidate cell based on a first CG resource, the transmitting of the first uplink data being a first uplink transmission performed by the terminal device in the first LTM candidate cell.

According to a second aspect, a terminal device is provided, and includes a memory and a processor, where the memory is configured to store a computer program, and the processor is configured to execute the computer program to cause the terminal device to: perform a first operation in a case that the terminal device determines to be handed over to a first LTM candidate cell, where the first operation includes one or more of following: initiating a random access procedure; or transmitting first uplink data in the first LTM candidate cell based on a first CG resource, the transmitting of the first uplink data being a first uplink transmission performed by the terminal device in the first LTM candidate cell.

According to a third aspect, a chip is provided, and includes a processor, configured to invoke a program from a memory, to cause a device on which the chip is installed to execute the method according to the first aspect.

### BRIEF DESCRIPTION OF DRAWINGS

FIG. 1 is an example diagram of a system architecture of a wireless communications system to which embodiments of this application are applicable.

FIG. 2 is a schematic diagram of a cell handover procedure based on L3 measurement.

FIG. 3 is a schematic diagram of a cell handover procedure based on LTM.

FIG. 4 is a schematic flowchart of a wireless communication method according to Embodiment 1 of this application.

FIG. 5 is an example diagram of a time interval between a reception time of a first instruction and a transmission opportunity of a CG resource, according to an embodiment of this application.

FIG. 6 is a schematic flowchart of a wireless communication method according to Embodiment 2 of this application.

FIG. 7 is a schematic structural diagram of a terminal device according to an embodiment of this application.

FIG. 8 is a schematic structural diagram of a terminal device according to another embodiment of this application.

FIG. 9 is a schematic structural diagram of a network device according to an embodiment of this application.

FIG. 10 is a schematic structural diagram of an apparatus according to an embodiment of this application.

### DESCRIPTION OF EMBODIMENTS

Technical solutions in this application are described below with reference to the accompanying drawings.

### Communications system architecture

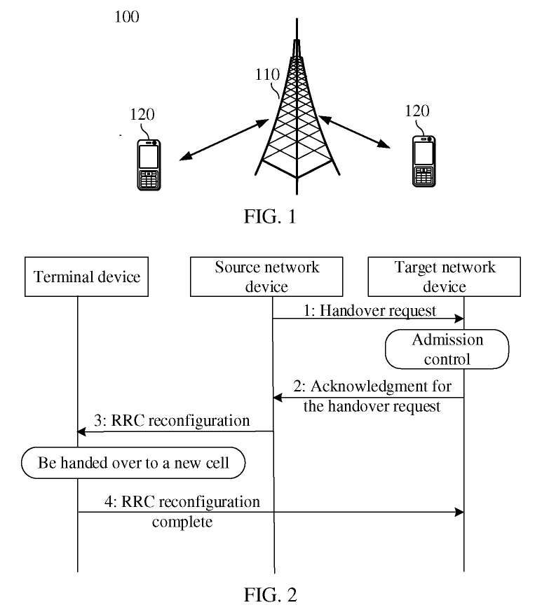

FIG. 1 is an example diagram of a system architecture of a wireless communications system 100 to which embodiments of this application are applicable. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

FIG. 1 shows one network device and one terminal device as an example. Optionally, the wireless communications system 100 may include one or more network devices 110, and/or one or more terminal devices 120. For a network device 110, the one or more terminal devices 120 may be located within network coverage of the network device 110, or may be located outside network coverage of the network device 110, or may be located partially within the network coverage of the network device 110, and may be located partially outside the network coverage of the network device 110, which is not limited in embodiments of this application.

Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, or an LTE time division duplex (TDD) system. The technical solutions provided in this application may further be applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover the following various names, or may be replaced with the following names, such as a NodeB, an evolved NodeB (eNB), a next generation NodeB (gNB), a relay station, an access point, a transmitting and receiving point (TRP), a transmitting point (TP), a master eNodeB MeNB, a secondary eNodeB SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (V2X), or machine-to-machine (M2M) communications, a network-side device in a 6G network, a device that functions as a base station in a future communications system, or the like. The base station may support networks of a same access technology or different access technologies. A specific technology and a specific device used by the network device are not limited in embodiments of this application.

The base station may be a fixed or mobile base station. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device may include a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may alternatively be implemented by software functions running on hardware, or by virtualization functions instantiated on a platform (for example, a cloud platform).

### Conventional handover

In a wireless communications system (such as an LTE system or an NR system), when a terminal device that is using a network service moves from one cell to another cell, or due to reasons such as load adjustment of a wireless transmission service, activation operation and maintenance, and a device fault, to ensure continuity and quality of service of communication of the terminal device, the system is required to transfer a communication link between the terminal device and the original cell to the new cell, that is, perform a cell handover procedure. The cell handover mechanism is conventional handover or cell handover based on L3 measurement/signalling.

The following briefly describes the cell handover procedure based on L3 measurement/signalling with reference to FIG. 2.

In step 1, a source network device transmits a handover request to a target network device.

The source network device may trigger a handover based on an L3 measurement result reported by the terminal, and transmit a handover request to a target cell via an Xn interface.

In step 2, the target network device transmits a handover request acknowledgment to the source network device.

The target network device may accept the handover request from the source network device, and provide an RRC configuration of the target network device as part of the handover request acknowledgment to be fed back to the source network device.

In step 3, the source network device transmits an RRC reconfiguration message to the terminal device.

The source network device transmits the RRC reconfiguration message to the terminal device, to instruct the terminal device to initiate a handover procedure, and provide the terminal device with RRC configuration information for accessing the target cell.

In step 4, the terminal device transmits an RRC reconfiguration complete message to the target network device.

The terminal device accesses the target cell, and transmits an RRC configuration complete message to the target cell. To establish uplink synchronization with the target cell, the terminal device is required to initiate a random access procedure to the target cell.

### LTM procedure

In a related technology, a handover procedure is triggered by L3 signalling (RRC reconfiguration). To further reduce latency of the L3 handover procedure, R18 study on the mobility will support a cell handover triggered by L1/L2 signalling, that is, LTM.

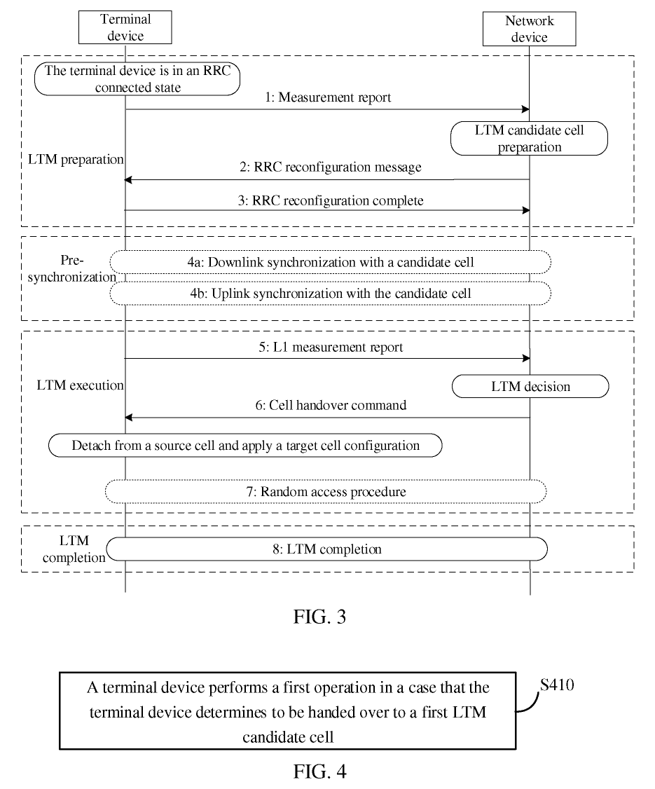

An LTM-based cell handover procedure may be divided into four stages: LTM preparation, pre-synchronization, LTM execution, and LTM completion. The following briefly describes the LTM-based cell handover procedure with reference to FIG. 3.

Stage 1: LTM preparation (corresponding to steps 1 to 3 in FIG. 3)

In step 1, a terminal device in an RRC connected state reports a measurement report to a network device.

The measurement report in this step is obtained based on L3 measurement. The network device may determine to initiate an LTM procedure based on a measurement result, and trigger candidate cell preparation.

In step 2, the network device transmits an RRC reconfiguration message to the terminal device.

The RRC reconfiguration message may include configuration information of an LTM candidate cell. There may be one or more LTM candidate cells.

In step 3, the terminal device stores the configuration information of the LTM candidate cell, and feeds back an RRC reconfiguration complete message to the network device.

Stage 2: pre-synchronization (corresponding to steps 4a and 4b in FIG. 3)

In step 4a, the terminal device performs downlink synchronization with the candidate cell.

In step 4b, the terminal device performs uplink synchronization with the candidate cell.

Before receiving an LTM cell handover command, the terminal device may perform uplink/downlink synchronization with the LTM candidate cell in advance, so as to reduce an interrupt delay in the handover procedure.

Stage 3: LTM execution (corresponding to steps 5 to 7 in FIG. 3)

In step 5, the terminal device performs L1 measurement on candidate cells, and reports L1 measurement results to the network device.

In step 6, the network device determines a target cell based on the L1 measurement results reported by the terminal device, and instructs, by using a medium access control control element (MAC CE), the terminal device to be handed over to the target cell.

In step 7, if the terminal device currently has no valid timing advance (TA) for the target cell, the terminal device initiates a random access procedure to the target cell after receiving an LTM handover indication.

Stage 4: LTM completion (step 8)

In step 8, the terminal device transmits indication information indicating that LTM has been successfully completed, to the target cell.

### Configured grant configured grant, CG resource selection based on beam quality

In Rel-16 and earlier protocol versions, a terminal device does not support data transmission in an RRC inactive state (RRC_INACTIVE state). When uplink or downlink data arrives, the terminal device is required to resume an RRC connection. After data transmission is completed, a network device selects to instruct the terminal device to re-enter the RRC_INACTIVE state. For terminal devices with small amounts of data and low transmission frequency, such state transitions result in unnecessary power consumption and signalling overheads. Therefore, Rel-17 initiated a study item to support the terminal device in transmitting small amounts of data in the RRC_INACTIVE state, namely, small data transmission (SDT). SDT supports two data transmission schemes: random access-small data transmission (RA-SDT) and configured grant-small data transmission (CG-SDT, or SDT over Configured Grant). RA-SDT may also be referred to as small data transmission over random access channel (SDT over RACH).

One of differences between RA-SDT and CG-SDT lies in whether the terminal device is required to perform a first uplink transmission carrying a common control channel (CCCH) message to the network device through random access. For uplink transmission services with relatively fixed data volume and periodicity, the network device may configure a set of dedicated CG resources for the terminal device by using an RRC release message. When satisfying a condition for triggering CG-SDT, the terminal device may directly perform uplink data transmission by using the set of CG resources, thereby avoiding latency and signalling overheads generated by a random access procedure.

The random access procedure is used to establish uplink synchronization between the terminal device and the network device. In addition, the network device may further determine downlink beam information based on a random access resource selected by the terminal device. Therefore, it is necessary to consider, in the design of the CG-SDT procedure, how to complete exchanges of TA and downlink beam information between the terminal device and the network device without initiating a random access procedure.

Regarding TA, the CG-SDT procedure allows the terminal device to use CG-SDT only when the TA is valid. Whether the TA is valid may be determined according to the following two criteria: first, whether the terminal device still resides in a cell in which the terminal device receives a CG-SDT resource configuration at a time of initiating SDT; and second, whether a TA timer is in a running state and whether a change in reference signal received power (RSRP) exceeds a pre-configured RSRP threshold.

To indicate the downlink beam information to the network device, the CG-SDT resource configuration follows a design manner similar to that in which a random access resource is associated with beam information. In other words, when configuring a CG-SDT resource, the network device is required to explicitly indicate a mapping relationship between each CG resource and a synchronization signal/physical broadcast channel block (SSB). The terminal device selects a CG-SDT resource corresponding to an SSB that meets a threshold to perform uplink data transmission, thereby assisting the network device in determining beam information for the data transmission.

### Random access channel–less LTM RACH-less LTM

TA and beam information (beam indication) of a target cell may be indicated in an LTM cell handover command. After receiving the cell handover command that includes the TA and the beam information, the terminal device may directly perform uplink transmission in the target cell, without exchanging the TA and the beam information with the network device through a random access procedure, thereby reducing an interrupt delay in the handover procedure. Such an LTM procedure may be referred to as RACH-less LTM.

A resource used by the terminal device to perform a first uplink transmission in the target cell includes an uplink resource dynamically scheduled by the target cell by using a physical downlink control channel (physical downlink control channel, PDCCH); or a CG resource included in a candidate cell configuration.

The CG resource follows a configuration manner similar to that of CG-SDT, that is, there is an association relationship between each CG resource and an SSB, and the terminal device is required to perform transmission of a first piece of uplink data on a CG resource associated with a beam indicated (Configured grant can be used for RACH-less LTM, for the first UL data transmission to the target cell, the UE selects the configured grant occasion, which is associated with the beam indicated in the LTM MAC CE (as set by source cell)).

It may be learned from the foregoing description that, the LTM procedure is a cell handover procedure triggered by L1/L2 signalling. In an LTM procedure, when a terminal device determines to be handed over to an LTM candidate cell, how to access the LTM candidate cell is a problem to be resolved. For example, whether a CG resource should be used or how to properly use a CG resource during the LTM procedure or after the LTM procedure is completed. For another example, how to determine whether a first piece of uplink data can be transmitted by using a CG resource. For another example, after the first piece of uplink data is transmitted by using the CG resource, and before the terminal device receives an acknowledgment (ACK) from the network device for the first piece of uplink data, whether a new transmission, a retransmission, or a fallback (that is, a fallback to performing cell access by initiating a random access procedure) can be performed. For another example, after the LTM procedure is completed, how the terminal device should handle the CG resource.

In view of the one or more problems mentioned above, the following describes embodiments of this application in detail. Embodiment 1 below mainly focuses on an LTM handover procedure. Embodiment 2 below mainly focuses on a procedure after an LTM procedure is completed.

### Embodiment 1:

FIG. 4 is a schematic flowchart of a wireless communication method according to Embodiment 1 of this application. The method in FIG. 4 includes step S410, that is, a terminal device performs a first operation in a case that the terminal device determines to be handed over to a first LTM candidate cell.

In some embodiments, the terminal device being handed over to the first LTM candidate cell may be triggered by a first instruction. The first instruction may sometimes be referred to as a cell handover command. The first instruction may be transmitted by a source cell.

In some embodiments, the first instruction may be a MAC CE instruction.

In some embodiments, the first instruction may include one or more of the following: an identity (ID) of the first LTM candidate cell, TA, a joint transmission configuration indicator TCI state (joint transmission configuration indicator state, Joint TCI state), an uplink/downlink TCI state (UL/DL TCI state), or a serving cell index.

In some embodiments, the first operation may include initiating a random access procedure.

In some embodiments, the first operation may include transmitting first uplink data in the first LTM candidate cell based on a first CG resource. The first CG resource is a CG resource that may be used in an LTM execution procedure. The first CG resource may be configured in configuration information of the first LTM candidate cell. For example, the configuration information of the first LTM candidate cell may include configuration information of the first CG resource, and the configuration information of the first CG resource may be used to configure the first CG resource. The transmitting of the first uplink data may be a first uplink transmission performed by the terminal device in the first LTM candidate cell.

In some embodiments, the first uplink data may include one or more of the following: uplink user plane data, a CCCH message, or a MAC CE.

In some embodiments, the first operation may be determined based on one or more of the following information: the configuration information of the first LTM candidate cell, beam measurement information, a first time, or a second time. For example, the terminal device may determine, based on one or more of the information described above, whether to transmit the first uplink data by using a CG resource.

The first time may be determined based on a reception time of the first instruction or an LTM execution time. For example, the first time may be the reception time of the first instruction or the LTM execution time.

The second time may be determined based on a time domain location corresponding to a CG resource associated with a first beam in the first CG resource.

In some embodiments, the first beam may be a beam indicated by the first instruction. It should be understood that the beam may have an association relationship with an SSB. Therefore, the beam may be indicated or measured in a manner of indicating or measuring the SSB. Alternatively, an indication or measurement of a beam mentioned in embodiments of this application may be replaced with an indication or measurement of an SSB.

In some embodiments, the first beam may be a beam selected by the terminal device based on layer-1 measurement (or a beam selected by the terminal device based on layer-1 measurement in an LTM procedure).

In some embodiments, the second time may be a time corresponding to the time domain location that corresponds to the CG resource associated with the first beam in the first CG resource. For example, the second time may be a time corresponding to a start location, an end location, or a middle location of the time domain location.

In some embodiments, the second time is a target transmission occasion (that is, a time corresponding to the transmission opportunity), corresponding to the CG resource associated with the first beam, in the first CG resource. The target transmission occasion may be a first transmission occasion after the first time among the transmission opportunity of the CG resource associated with the first beam.

Several possible implementations of step S410 are provided below.

### Implementation 1:

In implementation 1, step S410 may include one or more of the following steps: initiating, by the terminal device, a random access procedure in a case that no CG resource is configured in the configuration information of the first LTM candidate cell (that is, the first operation is initiating the random access procedure); and/or transmitting, by the terminal device, the first uplink data based on the first CG resource in a case that the first CG resource is configured in the configuration information of the first LTM candidate cell (that is, the first operation is transmitting the first uplink data based on the first CG resource).

In some embodiments, in a case in which the terminal device determines to initiate a random access procedure, and if a CFRA resource is configured in the configuration information of the first LTM candidate cell, the terminal device initiates a CFRA procedure (or preferentially initiates a CFRA procedure).

In some embodiments, in a case in which the terminal device determines to initiate a random access procedure, and if no CFRA resource is configured in the configuration information of the first LTM candidate cell, the terminal device initiates a CBRA procedure.

In some embodiments, in a case in which the terminal device determines to initiate a random access procedure, the terminal device may initiate the random access procedure by using a random access resource associated with the first beam. For description of the first beam, reference is made to the foregoing description. Alternatively, the terminal device may re-perform a beam selection process.

### Implementation 2:

In implementation 2, step S410 may include one or more of the following steps: in a case that no CG resource associated with the first beam (for description of the first beam, reference may be made to the foregoing description) is configured in the configuration information of the first LTM candidate cell, initiating, by the terminal device, a random access procedure (that is, the first operation is initiating the random access procedure); and/or in a case that the first CG resource configured by the first LTM candidate cell includes a CG resource associated with the first beam, transmitting, by the terminal device, the first uplink data based on the CG resource associated with the first beam (that is, the first operation is transmitting the first uplink data based on the first CG resource). For example, if a set of CG resources is configured in the configuration information of the first LTM candidate cell, but the set of resources is not associated with the first beam, the terminal device initiates a random access procedure.

In some embodiments, in a case in which the terminal device determines to initiate a random access procedure, and if a CFRA resource is configured in the configuration information of the first LTM candidate cell, the terminal device initiates a CFRA procedure (or preferentially initiates a CFRA procedure).

In some embodiments, in a case in which the terminal device determines to initiate a random access procedure, and if no CFRA resource is configured in the configuration information of the first LTM candidate cell, the terminal device initiates a CBRA procedure.

In some embodiments, in a case in which the terminal device determines to initiate a random access procedure, the terminal device may initiate the random access procedure by using a random access resource associated with the first beam. Alternatively, the terminal device may re-perform a beam selection process.

### Implementation 3:

In implementation 3, step S410 may include one or more of the following steps: in a case that a time interval between the second time and the first time (for description of the first time and the second time, reference may be made to the foregoing description) is greater than a first threshold, initiating, by the terminal device, a random access procedure (that is, the first operation is initiating the random access procedure); and/or in a case that the time interval between the second time and the first time is less than or equal to the first threshold, transmitting, by the terminal device, the first uplink data based on the CG resource associated with the first beam in the first CG resource (that is, the first operation is transmitting the first uplink data based on the first CG resource).

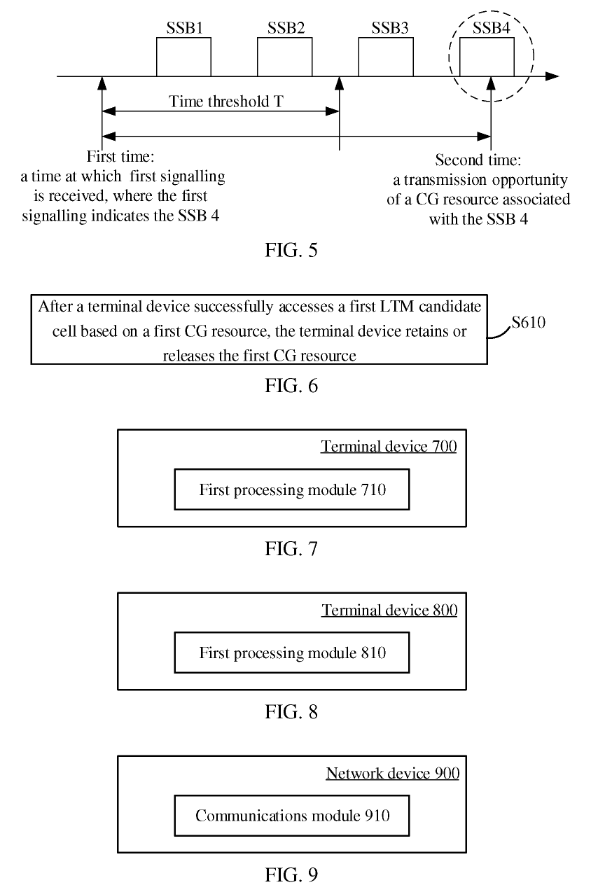

FIG. 5 is used as an example for description. Referring to FIG. 5, the first time is the reception time of the first instruction, and the second time is the time corresponding to the time domain location of the CG resource associated with the first beam (or the second time is the transmission occasion of the CG resource associated with the first beam). If the time interval between the first time and the second time is greater than a time threshold T (corresponding to the first threshold), the terminal device may initiate a random access procedure.

In some embodiments, in a case in which the terminal device determines to initiate a random access procedure, and if a CFRA resource is configured in the configuration information of the first LTM candidate cell, the terminal device initiates a CFRA procedure (or preferentially initiates a CFRA procedure).

In some embodiments, in a case in which the terminal device determines to initiate a random access procedure, and if no CFRA resource is configured in the configuration information of the first LTM candidate cell, the terminal device initiates a CBRA procedure.

In some embodiments, in a case in which the terminal device determines to initiate a random access procedure, the terminal device may initiate the random access procedure by using a random access resource associated with the first beam. For description of the first beam, reference is made to the foregoing description. Alternatively, the terminal device may re-perform a beam selection process.

### Implementation 4:

In implementation 4, step S410 may include one of the following: in a case that a first condition is satisfied before the first uplink data is transmitted, initiating, by the terminal device, a random access procedure; or in a case that a first condition is satisfied before the first uplink data is transmitted, transmitting, by the terminal device, the first uplink data based on a CG resource associated with a second beam in the first CG resource.

In some embodiments, the first condition may be or indicate that the terminal device detects a change in the beam.

In some embodiments, the first condition may be determined based on beam measurement information. For example, the first condition may be associated with one or more of the following: beam measurement information of the first beam; or beam measurement information of the second beam. The second beam mentioned here may refer to another beam whose beam quality measured by the terminal device is higher than that of the first beam.

For example, the first condition includes one or more of the following: the beam quality of the first beam being less than or equal to a second threshold; a difference between the beam quality of the second beam and the beam quality of the first beam being greater than or equal to a third threshold; or the second beam being a beam having the highest beam quality indicated by the beam measurement information.

In an example, if the beam quality of the first beam is less than or equal to the second threshold, the terminal device initiates a random access procedure; and/or, if the beam quality of the first beam is greater than the second threshold, the terminal device transmits the first uplink data based on the CG resource associated with the first beam in the first CG resource.

In another example, if the difference between the beam quality of the second beam and the beam quality of the first beam is greater than or equal to a third threshold, the terminal device transmits the first uplink data based on the CG resource associated with the second beam in the first CG resource. If the difference between the beam quality of the second beam and the beam quality of the first beam is greater than or equal to the third threshold, the terminal device initiates a random access procedure, or the terminal device transmits the first uplink data based on the CG resource associated with the second beam in the first CG resource.

In still another example, if the second beam is a beam having the highest beam quality indicated by the beam measurement information, the terminal device transmits the first uplink data based on the CG resource associated with the second beam in the first CG resource.

In some embodiments, before determining whether the first condition is satisfied, the terminal device is required to first determine whether there is a CG resource associated with the second beam in the first CG resource. If there is no CG resource associated with the second beam in the first CG resource, the terminal device may initiate a random access procedure.

How to determine whether to transmit the first uplink data based on the first CG resource is described in detail above. The following describes in detail possible behavior of the terminal device after the terminal device transmits the first uplink data based on the first CG resource. It should be understood that content described below may be combined with or be separate from the content described above.

In some embodiments, the method in FIG. 4 may further include: starting, by the terminal device, a first timer after transmitting the first uplink data based on the first CG resource. During operation of the first timer, the terminal device does not transmit (or cannot transmit) second uplink data (the second uplink data may refer to a new transmission or an initial transmission of another piece of uplink data) in the first LTM candidate cell by using a CG resource other than the first CG resource.

In some embodiments, the method in FIG. 4 may further include: starting, by the terminal device, a second timer after transmitting the first uplink data based on the first CG resource; and retransmitting, by the terminal device, the first uplink data when the second timer expires.

In some embodiments, the first uplink data is retransmitted based on a second CG resource, and the second CG resource and the first CG resource are associated with a same HARQ process and/or beam. In other words, the CG resource for retransmitting the first uplink data may be associated with the same HARQ process and/or beam as the CG resource used for the previous transmission of the first uplink data.

In some embodiments, the method in FIG. 4 may further include: retransmitting, by the terminal device, the first uplink data on a second CG resource after transmitting the first uplink data based on the first CG resource, where the second CG resource is a CG resource adjacent to the first CG resource in a target CG resource, the target CG resource and the first CG resource being associated with a same HARQ process and/or beam. In this embodiment, the terminal device retransmits the first uplink data without relying on the second timer mentioned above, but may transmit the first uplink data on each pair of adjacent CG resources that are associated with a same HARQ process and/or beam.

In some embodiments, the method in FIG. 4 may further include: performing, by the terminal device, a second operation in a case that the first timer expires and the terminal device fails to receive acknowledgment information (ACK) for the first uplink data. The second operation includes one of the following: transmitting first indication information (used to indicate that an LTM procedure fails) to an RRC layer of the terminal device; and initiating a random access procedure.

For example, if the first timer expires, and the terminal device fails to receive acknowledgment information for the first uplink data, the terminal device (a MAC layer of the terminal device) transmits the first indication information to the RRC layer of the terminal device, to indicate that an LTM procedure fails. After the first indication information is received, the RRC layer of the terminal device stops the third timer (for example, a T304 timer used for cell handover, or a timer that has a function similar to that of T304), and triggers an RRC connection re-establishment procedure.

For another example, if the first timer expires, and the terminal device fails to receive the acknowledgment information for the first uplink data, the terminal device initiates a random access procedure.

In some embodiments, the method in FIG. 4 may further include: in a case that a third timer (for example, a T304 timer used for cell handover, or a timer that has a function similar to that of T304) maintained by an RRC layer of the terminal device expires, and the terminal device fails to receive acknowledgment information for the first uplink data, determining, by the terminal device, that an LTM procedure fails. In this embodiment, the terminal device may not start the second timer mentioned above.

### Embodiment 2:

FIG. 6 is a schematic flowchart of a wireless communication method according to Embodiment 2 of this application. The method in FIG. 6 may include step S610, that is, after the terminal device successfully accesses the first LTM candidate cell based on the first CG resource, the terminal device retains or releases the first CG resource.

In some embodiments, the configuration information of the first CG resource (may be included in the configuration information of the first LTM candidate cell) includes one or more of the following information: first indication information, used to indicate whether the terminal device releases the first CG resource after successfully accessing the first LTM candidate cell; or second indication information, used to indicate whether the terminal device retains the first CG resource after successfully accessing the first LTM candidate cell. Accordingly, before the terminal device successfully accesses the first LTM candidate cell based on the first CG resource, the network device may transmit the configuration information of the first LTM candidate cell to the terminal device. The configuration information of the first LTM candidate cell includes the configuration information of the first CG resource, and the configuration information of the first CG resource may include the first indication information and/or second indication information mentioned above.

### Embodiment 2.1: The terminal device releases the first CG resource

In some embodiments, the terminal device releasing the first CG resource mentioned above may include: releasing, by the MAC layer of the terminal device, the first CG resource; and/or, releasing, by the RRC layer of the terminal device, the first CG resource. For example, the terminal device may determine, based on the first indication information mentioned above, whether to perform a release operation of the first CG resource after successfully accessing the first LTM candidate cell based on the first CG resource. For another example, the terminal device may perform a release operation of the first CG resource by default after successfully accessing the first LTM candidate cell based on the first CG resource.

In some embodiments, after first acknowledgment information is received, the MAC layer of the terminal device releases the first CG resource. The first acknowledgment information may also be referred to as an acknowledgment indication, and may refer to an ACK corresponding to the first uplink data (that is, the data transmitted during the first uplink transmission) transmitted based on the first CG resource. Further, in some embodiments, the MAC layer of the terminal device transmits the second indication information to the RRC layer. The second indication information may be used to indicate that the MAC layer has released the first CG resource.

In some embodiments, after the first acknowledgment information is received, the MAC layer of the terminal device may transmit third indication information to the RRC layer. The third indication information may be used to indicate that an LTM procedure has been successfully completed. After the third indication information is received, the RRC layer of the terminal device may transmit fourth indication information to the MAC layer, the fourth indication information being used to indicate that the MAC layer has released the first CG resource.

### Embodiment 2.2: The terminal device retains the first CG resource

In some embodiments, the RRC layer of the terminal device retains the first CG resource, and the MAC layer of the terminal device releases the first CG resource.

In some embodiments, both the RRC layer and the MAC layer of the terminal device retain the first CG resource.

In some embodiments, the terminal device may determine, based on the second indication information mentioned above, whether to retain the first CG resource after successfully accessing the first LTM candidate cell.

In some embodiments, the terminal device retains the first CG resource by default after successfully accessing the first LTM candidate cell.

In some embodiments, a CG resource associated with an operating beam of the terminal device in the first CG resource may be used for performing data transmission, for example, transmitting uplink data. For example, the terminal device may perform data transmission in a transmission opportunity corresponding to the CG resource associated with the operating beam.

In some embodiments, a CG resource not associated with the operating beam in the first CG resource may be released or suspended (suspend).

In some embodiments, the operating beam of the terminal device that is mentioned above may be a beam indicated by the first instruction. The first instruction may be used to instruct the terminal device to be handed over to the first LTM candidate cell. For detailed description of the first instruction, reference may be made to Embodiment 1.

In some embodiments, the operating beam of the terminal device that is mentioned above may be a beam selected by the terminal device based on layer-1 (L1) measurement during an LTM procedure.

In some embodiments, the operating beam of the terminal device that is mentioned above may be a beam re-determined for the terminal device in the first LTM candidate cell through a beam management (BM) process. Alternatively, the operating beam of the terminal device may be a beam dynamically updated for the terminal device by the first LTM candidate cell through the BM process.

For example, if the operating beam of the terminal device in the first LTM candidate cell is a beam 2, the terminal device may perform data transmission by using a transmission opportunity (CG occasion) corresponding to a CG resource associated with the beam 2 in the first CG resource. At a next instant, assuming that the first LTM candidate cell updates the operating beam of the terminal device to a beam 3, accordingly, the terminal device may perform data transmission by using a transmission opportunity (CG occasion) corresponding to a CG resource associated with the beam 3 in the first CG resource.

In some embodiments, the first CG resource may be used for a target process. The target process may include one or more of the following: a beam management process triggered by the terminal device; mobile original-SDT (mobile original-SDT, MO-SDT) MO-SDT; or mobile terminated-SDT (MT-SDT).

In some embodiments, the first CG resource may not be used for the target process. The target process may include one or more of the following: a beam management process triggered by the terminal device; MO-SDT; or MT-SDT.

In some embodiments, whether the first CG resource can be used for the target process may be determined based on indication information from the network device.

In some embodiments, the method in FIG. 5 may further include: receiving, by the terminal device, a second instruction transmitted by the network device. The second instruction may be used to indicate one or more of the following: whether to resume using the first CG resource; whether to activate the first CG resource; or whether to cancel an association relationship between the first CG resource and a beam.

In some embodiments, before the terminal device receives the second instruction transmitted by the network device, the terminal device suspends the first CG resource.

In some embodiments, the second instruction may be carried in one of the following: downlink control information (DCI), a MAC CE, or a radio resource control (RRC) message.

In some embodiments, after successfully accessing the first LTM candidate cell, the terminal device may cancel the association relationship between the first CG resource and the beam.

In some embodiments, an operation of cancelling the association relationship between the first CG resource and the beam may be: an operation indicated by the network device after the terminal device successfully accesses the first LTM candidate cell. The indication may be, for example, provided by the network device based on the second instruction mentioned above.

In some embodiments, an operation of cancelling the association relationship between the first CG resource and the beam may be: a default operation performed by the terminal device after successfully accessing the first LTM candidate cell, without additional indication by the network device. In other words, after the terminal device successfully accesses the first LTM candidate cell, the terminal device may perform uplink data transmission by using the first CG resource, without complying with an association relationship between a CG resource and a beam.

In some embodiments, an operation of cancelling the association relationship between the first CG resource and the beam may be: an operation indicated by third indication information included in the configuration information of the first CG resource. Accordingly, before the terminal device successfully accesses the first LTM candidate cell, the network device transmits the configuration information of the first LTM candidate cell to the terminal device. The configuration information of the first LTM candidate cell includes the configuration information of the first CG resource, and the configuration information of the first CG resource includes the third indication information.

The method embodiments of this application are described above in detail with reference to FIG. 1 to FIG. 6. Apparatus embodiments of this application are described below in detail with reference to FIG. 7 to FIG. 10. It should be understood that the descriptions of the method embodiments correspond to descriptions of the apparatus embodiments, and therefore, for parts that are not described in detail, reference may be made to the foregoing method embodiments.

FIG. 7 is a schematic structural diagram of a terminal device according to an embodiment of this application. The terminal device 700 shown in FIG. 7 may include a first processing module 710. The first processing module 710 may be configured to perform a first operation in a case that the terminal device determines to be handed over to a first LTM candidate cell. The first operation includes one or more of the following: initiating a random access procedure; or transmitting first uplink data in the first LTM candidate cell based on a first CG resource, the transmitting of the first uplink data being a first uplink transmission performed by the terminal device in the first LTM candidate cell.

In some embodiments, the first operation is determined based on one or more of the following information: configuration information of the first LTM candidate cell; beam measurement information; a first time determined based on a reception time of a first instruction or an LTM execution time, the first instruction being used to instruct the terminal device to be handed over to the first LTM candidate cell; or a second time determined based on a time domain location corresponding to a CG resource associated with a first beam in the first CG resource, the first beam being a beam indicated by the first instruction or a beam selected by the terminal device based on layer-1 measurement.

In some embodiments, the first processing module is configured to: initiate a random access procedure in a case that no CG resource is configured in the configuration information of the first LTM candidate cell; and/or transmit, by the terminal device, the first uplink data based on the first CG resource in a case that the first CG resource is configured in the configuration information of the first LTM candidate cell.

In some embodiments, the first processing module is configured to: in a case that no CG resource associated with the first beam is configured in the configuration information of the first LTM candidate cell, initiate a random access procedure; and/or in a case that the first CG resource configured by the first LTM candidate cell includes a CG resource associated with the first beam, transmit, by the terminal device, the first uplink data based on the CG resource associated with the first beam.

In some embodiments, the first processing module is configured to: in a case that a time interval between the second time and the first time is greater than a first threshold, initiate a random access procedure; and/or in a case that the time interval between the second time and the first time is less than or equal to the first threshold, transmit, by the terminal device, the first uplink data based on the CG resource associated with the first beam in the first CG resource.

In some embodiments, the first processing module is configured to: in a case that a first condition is satisfied before the first uplink data is transmitted, perform one of the following operations: initiating a random access procedure; and transmitting the first uplink data based on a CG resource associated with a second beam in the first CG resource. The first condition is associated with one or more of the following: beam measurement information of the first beam; or beam measurement information of the second beam, where beam quality of the second beam is higher than beam quality of the first beam.

In some embodiments, the first condition includes one or more of the following: the beam quality of the first beam being less than or equal to a second threshold; a difference between the beam quality of the second beam and the beam quality of the first beam being greater than or equal to a third threshold; or the second beam being a beam having the highest beam quality indicated by the beam measurement information.

In some embodiments, the terminal device further includes: a second processing module, configured to start a first timer after transmitting the first uplink data based on the first CG resource. During operation of the first timer, the terminal device does not transmit second uplink data in the first LTM candidate cell by using a CG resource other than the first CG resource.

In some embodiments, the terminal device further includes: a third processing module, configured to perform a second operation in a case that the first timer expires and the terminal device fails to receive acknowledgment information for the first uplink data. The second operation includes one of the following: transmitting first indication information to an RRC layer of the terminal device, where the first indication information is used to indicate that an LTM procedure fails; and initiating a random access procedure.

In some embodiments, the terminal device further includes: a fourth processing module, configured to control the RRC layer of the terminal device to stop a third timer, and trigger an RRC connection re-establishment procedure after the first indication information is received.

In some embodiments, the terminal device further includes: a fifth processing module, configured to start a second timer after transmitting the first uplink data based on the first CG resource; and retransmit the first uplink data when the second timer expires.

In some embodiments, the first uplink data is retransmitted based on a second CG resource, and the second CG resource and the first CG resource are associated with a same HARQ process and/or beam.

In some embodiments, the terminal device further includes: a sixth processing module, configured to: in a case that a third timer maintained by an RRC layer of the terminal device expires, and the terminal device fails to receive acknowledgment information for the first uplink data, determine that an LTM procedure fails.

In some embodiments, the terminal device further includes: a communications module, configured to retransmit the first uplink data on a second CG resource after transmitting the first uplink data based on the first CG resource. The second CG resource is a CG resource adjacent to the first CG resource in a target CG resource, the target CG resource and the first CG resource being associated with a same HARQ process and/or beam.

In some embodiments, the first processing module is configured to: in a case that a contention-free random access (CFRA) resource is configured in configuration information of the first LTM candidate cell, initiate a CFRA procedure; and/or in a case that no CFRA resource is configured in the configuration information of the first LTM candidate cell, initiate, by the terminal device, a contention-based random access (CBRA) procedure.

In some embodiments, the first processing module is configured to initiate the random access procedure by using a random access resource associated with the first beam. The first beam is a beam indicated by a first instruction or a beam selected by the terminal device based on layer-1 measurement, the first instruction being used to instruct the terminal device to be handed over to the first LTM candidate cell.

In some embodiments, the terminal device further includes: a seventh processing module, configured to re-perform a beam selection process before the terminal device initiates a random access procedure.

FIG. 8 is a schematic structural diagram of a terminal device according to another embodiment of this application. The terminal device 800 shown in FIG. 8 may include a first processing module 810. The first processing module 810 is configured to: after the terminal device successfully accesses a first LTM candidate cell based on a first CG resource, retain or release the first CG resource.

In some embodiments, configuration information of the first CG resource includes one or more of the following: first indication information, used to indicate whether the terminal device releases the first CG resource after successfully accessing the first LTM candidate cell; or second indication information, used to indicate whether the terminal device retains the first CG resource after successfully accessing the first LTM candidate cell.

In some embodiments, the first processing module is configured to: control a MAC layer of the terminal device to release the first CG resource; and/or control an RRC layer of the terminal device to release the first CG resource.

In some embodiments, the first processing module is configured to: control a MAC layer of the terminal device to release the first CG resource after first acknowledgment information is received; and/or control the MAC layer of the terminal device to transmit second indication information to an RRC layer, the second indication information being used to indicate that the MAC layer has released the first CG resource.

In some embodiments, the first processing module is configured to: control a MAC layer of the terminal device to transmit third indication information to an RRC layer after first acknowledgment information is received, the third indication information being used to indicate that an LTM procedure has been successfully completed; and control the RRC layer of the terminal device to transmit fourth indication information to the MAC layer after the third indication information is received, the fourth indication information being used to indicate that the MAC layer has released the first CG resource.

In some embodiments, the first processing module is configured to: control an RRC layer of the terminal device to retain the first CG resource, and control a MAC layer of the terminal device to release the first CG resource; or control both the RRC layer and the MAC layer of the terminal device to retain the first CG resource.

In some embodiments, in a case in which the first CG resource is retained, a CG resource associated with an operating beam of the terminal device in the first CG resource may be used for transmitting uplink data.

In some embodiments, a CG resource not associated with the operating beam in the first CG resource is released or suspended.

In some embodiments, the operating beam includes one of the following: a beam indicated by a first instruction, the first instruction being used to instruct the terminal device to be handed over to the first LTM candidate cell; a beam selected by the terminal device during an LTM procedure based on layer-1 measurement; and a beam re-determined for the terminal device in the first LTM candidate cell through a beam management process.

In some embodiments, in a case in which the first CG resource is retained, the first CG resource is used or not used for a target process. The target process includes one or more of the following: a beam management process triggered by the terminal device; MO-SDT; or MT-SDT.

In some embodiments, whether the first CG resource is used for the target process may be determined based on indication information from the network device.

In some embodiments, the terminal device further includes: a communications module, configured to receive a second instruction transmitted by a network device, the second instruction being used to indicate one or more of the following: whether to resume using the first CG resource; whether to activate the first CG resource; or whether to cancel an association relationship between the first CG resource and a beam.

In some embodiments, the terminal device further includes: a second processing module, configured to suspend the first CG resource before the terminal device receives the second instruction transmitted by the network device.

In some embodiments, the terminal device further includes: a third processing module, configured to cancel an association relationship between the first CG resource and a beam after successfully accessing the first LTM candidate cell.

In some embodiments, an operation of cancelling the association relationship between the first CG resource and the beam includes one of the following: a default operation performed by the terminal device after successfully accessing the first LTM candidate cell; an operation indicated by third indication information included in configuration information of the first CG resource; and an operation indicated by a network device after the terminal device successfully accesses the first LTM candidate cell.

FIG. 9 is a schematic structural diagram of a network device according to an embodiment of this application. The network device 900 shown in FIG. 9 may include a communications module 910. The communications module 910 may be configured to transmit configuration information of a first LTM candidate cell to a terminal device, the configuration information of the first LTM candidate cell including configuration information of a first CG resource, and the configuration information of the first CG resource including one or more of following information: first indication information, used to indicate whether the terminal device releases the first CG resource after successfully accessing the first LTM candidate cell; second indication information, used to indicate whether the terminal device retains the first CG resource after successfully accessing the first LTM candidate cell; or third indication information, used to instruct the terminal device to cancel an association relationship between the first CG resource and a beam after successfully accessing the first LTM candidate cell.

In some embodiments, the releasing the first CG resource includes: releasing, by a MAC layer of the terminal device, the first CG resource; and/or releasing, by an RRC layer of the terminal device, the first CG resource.

In some embodiments, the retaining the first CG resource includes: retaining, by an RRC layer of the terminal device, the first CG resource, and releasing, by a MAC layer of the terminal device, the first CG resource; or retaining, by both the RRC layer and the MAC layer of the terminal device, the first CG resource.

In some embodiments, in a case in which the first CG resource is retained, a CG resource associated with an operating beam of the terminal device in the first CG resource is used for transmitting uplink data.

In some embodiments, a CG resource not associated with the operating beam in the first CG resource is released or suspended.

In some embodiments, the operating beam includes one of the following: a beam indicated by a first instruction, the first instruction being used to instruct the terminal device to be handed over to the first LTM candidate cell; a beam selected by the terminal device during an LTM procedure based on layer-1 measurement; and a beam re-determined for the terminal device in the first LTM candidate cell through a beam management process.

In some embodiments, in a case in which the first CG resource is retained, the first CG resource is used or not used for a target process. The target process includes one or more of the following: a beam management process triggered by the terminal device; MO-SDT; or MT-SDT.

In some embodiments, whether the first CG resource is used for the target process may be determined based on indication information from the network device.

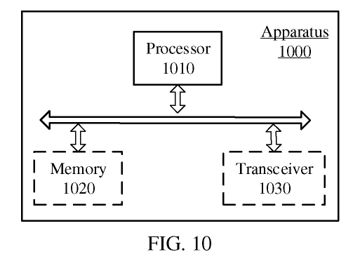

FIG. 10 is a schematic structural diagram of an apparatus according to an embodiment of this application. Dashed lines in FIG. 10 indicate that a unit or module is optional. The apparatus 1000 may be configured to implement the methods described in the foregoing method embodiments. The apparatus 1000 may be a chip, a terminal device, or a network device.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program that may be executed by the processor 1010 to cause the processor 1010 to perform the methods described in the foregoing method embodiments. The memory 1020 may be separated from or integrated into the processor 1010.

The apparatus 1000 may further include a transceiver 1030. The processor 1010 may communicate with another device or chip by using the transceiver 1030. For example, the processor 1010 may transmit data to and receive data from another device or chip through the transceiver 1030.

An embodiment of this application further provides a computer-readable storage medium for storing a program. The computer-readable storage medium may be applied to the terminal device or the network device provided in embodiments of this application, and the program causes a computer to execute a method executed by the terminal device or the network device in embodiments of this application.

An embodiment of this application further provides a computer program product. The computer program product includes a program. The computer program product may be applied to the terminal device or the network device provided in the embodiments of this application, and the program causes a computer to execute the methods performed by the terminal device or the network device in various embodiments of this application.

An embodiment of this application further provides a computer program. The computer program may be applied to the terminal device or the network device provided in the embodiments of this application, and the computer program causes a computer to execute the methods performed by the terminal device or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefining” or “pre-configuring” may be implemented by pre-storing corresponding code, tables, or other forms that may be used to indicate related information in devices (for example, including a terminal device and a network device), and a specific implementation thereof is not limited in this application. For example, being predefined may refer to being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” describes merely an association relationship between associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
performing, by a terminal device, a first operation in a case that the terminal device determines to be handed over to a first layer 1/layer 2-triggered mobility LTM candidate cell,
wherein the first operation comprises one or more of following:
initiating a random access procedure; or
transmitting first uplink data in the first LTM candidate cell based on a first configured grant CG resource, the transmitting of the first uplink data being a first uplink transmission performed by the terminal device in the first LTM candidate cell.

2. The method according to claim 1, wherein the first operation is determined based on one or more of following information:
configuration information of the first LTM candidate cell;
beam measurement information;
a first time determined based on a reception time of a first instruction or an LTM execution time, the first instruction being used to instruct the terminal device to be handed over to the first LTM candidate cell; or
a second time determined based on a time domain location corresponding to a CG resource associated with a first beam in the first CG resource, the first beam being a beam indicated by the first instruction or a beam selected by the terminal device based on layer-1 measurement.

3. The method according to claim 2, wherein the performing, by the terminal device, the first operation comprises:
initiating, by the terminal device, a random access procedure in a case that no CG resource is configured in the configuration information of the first LTM candidate cell; and/or
transmitting, by the terminal device, the first uplink data based on the first CG resource in a case that the first CG resource is configured in the configuration information of the first LTM candidate cell.

4. The method according to claim 2, wherein the performing, by the terminal device, the first operation comprises:
in a case that no CG resource associated with the first beam is configured in the configuration information of the first LTM candidate cell, initiating, by the terminal device, a random access procedure; and/or
in a case that the first CG resource configured by the first LTM candidate cell comprises a CG resource associated with the first beam, transmitting, by the terminal device, the first uplink data based on the CG resource associated with the first beam.

5. The method according to claim 2, wherein the performing, by the terminal device, the first operation comprises:
in a case that a time interval between the second time and the first time is greater than a first threshold, initiating, by the terminal device, a random access procedure; and/or
in a case that the time interval between the second time and the first time is less than or equal to the first threshold, transmitting, by the terminal device, the first uplink data based on the CG resource associated with the first beam in the first CG resource.

6. The method according to claim 2, wherein the performing, by the terminal device, the first operation comprises:
in a case that a first condition is satisfied before the first uplink data is transmitted, performing, by the terminal device, one of following operations:
initiating a random access procedure; and
transmitting the first uplink data based on a CG resource associated with a second beam in the first CG resource,
wherein the first condition is associated with one or more of following:
beam measurement information of the first beam; or
beam measurement information of the second beam, wherein beam quality of the second beam is higher than beam quality of the first beam.

7. The method according to claim 6, wherein the first condition comprises one or more of following:
the beam quality of the first beam being less than or equal to a second threshold;
a difference between the beam quality of the second beam and the beam quality of the first beam being greater than or equal to a third threshold; or
the second beam being a beam having the highest beam quality indicated by the beam measurement information.

8. The method according to claim 1, wherein the method further comprises:
starting, by the terminal device, a second timer after transmitting the first uplink data based on the first CG resource; and
retransmitting, by the terminal device, the first uplink data when the second timer expires.

9. The method according to claim 1, wherein the initiating, by the terminal device, the random access procedure comprises:
in a case that a contention-free random access CFRA resource is configured in configuration information of the first LTM candidate cell, initiating, by the terminal device, a CFRA procedure; and/or
in a case that no CFRA resource is configured in the configuration information of the first LTM candidate cell, initiating, by the terminal device, a contention-based random access CBRA procedure.

10. The method according to claim 1, wherein the initiating, by the terminal device, the random access procedure comprises:
initiating, by the terminal device, the random access procedure by using a random access resource associated with a first beam,
wherein the first beam is a beam indicated by a first instruction or a beam selected by the terminal device based on layer-1 measurement, the first instruction being used to instruct the terminal device to be handed over to the first LTM candidate cell.

11. A terminal device, comprising a memory and a processor, wherein the memory is configured to store a computer program, and the processor is configured to execute the computer program to cause the terminal device to:
perform a first operation in a case that the terminal device determines to be handed over to a first layer 1/layer 2-triggered mobility LTM candidate cell,
wherein the first operation comprises one or more of following:
initiating a random access procedure; or
transmitting first uplink data in the first LTM candidate cell based on a first configured grant CG resource, the transmitting of the first uplink data being a first uplink transmission performed by the terminal device in the first LTM candidate cell.

12. The terminal device according to claim 11, wherein the first operation is determined based on one or more of following information:
configuration information of the first LTM candidate cell;
beam measurement information;
a first time determined based on a reception time of a first instruction or an LTM execution time, the first instruction being used to instruct the terminal device to be handed over to the first LTM candidate cell; or
a second time determined based on a time domain location corresponding to a CG resource associated with a first beam in the first CG resource, the first beam being a beam indicated by the first instruction or a beam selected by the terminal device based on layer-1 measurement.

13. The terminal device according to claim 12, wherein the terminal device is configured to: initiate a random access procedure in a case that no CG resource is configured in the configuration information of the first LTM candidate cell; and/or transmit the first uplink data based on the first CG resource in a case that the first CG resource is configured in the configuration information of the first LTM candidate cell.

14. The terminal device according to claim 12, wherein the termimal device is configured to: in a case that no CG resource associated with the first beam is configured in the configuration information of the first LTM candidate cell, initiate a random access procedure; and/or in a case that the first CG resource configured by the first LTM candidate cell comprises a CG resource associated with the first beam, transmit the first uplink data based on the CG resource associated with the first beam.

15. The terminal device according to claim 12, wherein the terminal device is configured to: in a case that a time interval between the second time and the first time is greater than a first threshold, initiate a random access procedure; and/or in a case that the time interval between the second time and the first time is less than or equal to the first threshold, transmit the first uplink data based on the CG resource associated with the first beam in the first CG resource.

16. The terminal device according to claim 12, wherein the terminal device is configured to: in a case that a first condition is satisfied before the first uplink data is transmitted, perform one of following operations: initiating a random access procedure; and transmitting the first uplink data based on a CG resource associated with a second beam in the first CG resource, wherein the first condition is associated with one or more of following: beam measurement information of the first beam; or beam measurement information of the second beam, wherein beam quality of the second beam is higher than beam quality of the first beam.

17. The terminal device according to claim 16, wherein the first condition comprises one or more of following:
the beam quality of the first beam being less than or equal to a second threshold;
a difference between the beam quality of the second beam and the beam quality of the first beam being greater than or equal to a third threshold; or
the second beam being a beam having the highest beam quality indicated by the beam measurement information.

18. The terminal device according to claim 11, wherein the terminal device is further configured:
start a second timer after transmitting the first uplink data based on the first CG resource; and retransmit the first uplink data when the second timer expires.

19. The terminal device according to claim 11, wherein the terminal device is configured to: in a case that a contention-free random access CFRA resource is configured in configuration information of the first LTM candidate cell, initiate a CFRA procedure; and/or in a case that no CFRA resource is configured in the configuration information of the first LTM candidate cell, initiate a contention-based random access CBRA procedure.

20. A chip, comprising a processor, configured to invoke a program from a memory, to cause a device installed with the chip to execute the method according to claim 1.
